(19) United States
(12) Patent Application Publication
(10) Pub. No.: US 2021/0132453 A1
(43) Pub. Date: May 6, 2021

(54) LIQUID CRYSTAL DISPLAY DEVICE

(71) Applicant: SHARP KABUSHIKI KAISHA, Sakai City, Osaka (JP)

(72) Inventors: MASAKATSU TOMINAGA, Sakai City, Osaka (JP); MASAHIRO YOSHIDA, Sakai City, Osaka (JP)

(73) Assignee: SHARP KABUSHIKI KAISHA, Sakai City, Osaka (JP)

(21) Appl. No.: 16/616,847

(22) PCT Filed: May 29, 2018
(86) PCT No.: PCT/JP2018/020436

§ 371 Date: Nov. 25, 2019

(30) Foreign Application Priority Data
May 30, 2017 (JP) 2017-106077

(51) Int. Cl. G02F 1/1362; G02F 1/1343; G02F 1/1368; G09G 3/36

(52) U.S. Cl. CPC G02F 1/136286; G02F 1/134309; G02F 1/136222; G09G 3/3614; G02F 1/1368

(57) ABSTRACT

Provided is a liquid crystal display device in which it is unlikely that flicker would occur even if a polarity of a data voltage is inverted at every frame when a single color is displayed. The liquid crystal display device includes an active matrix substrate and a counter substrate. The active matrix substrate includes a plurality of pixels provided with pixel electrodes 16 arranged in matrix, and source lines SL to each of which a data voltage having either a positive polarity or a negative polarity is applied. The counter substrate includes color filters of a plurality of colors. The source lines are arranged in such a manner that two source lines (SLn, SLn+1/SLn+2, SLn+3) are provided with respect to each of pixel columns L1 and L2 each of which includes three columns of pixels. The polarity of the data voltage applied to the source line is inverted at every frame. Regarding each of the colors, the pixels corresponding to the color include the pixels having the pixel electrodes 16 connected with the source lines to which positive-polarity data voltages are applied, and the pixels having the pixel electrodes 16 connected with the source lines to which negative-polarity data voltages are applied.

### TECHNICAL FIELD

The present invention relates to a liquid crystal display device.

### BACKGROUND ART

Conventionally, a technique of periodically inverting the polarity of voltage to be applied to a pixel in order to prevent the deterioration of liquid crystal in a liquid crystal display device has been proposed. Such a liquid crystal display device is disclosed in JP-A-2007-188089. This liquid crystal display device includes a display panel in which pixels corresponding to colors of red (R), green (G), and blue (B) (hereinafter referred to as pixels R, pixels G, and pixels B, respectively) are arranged in matrix. In the display panel, three gate lines that are a first gate line, a second gate line, and a third gate line are provided with respect to every two pixel rows. Pixel electrodes of the pixels R and the pixels B in one of the two pixel rows are connected with the first gate lines. Pixel electrodes of the pixels R and the pixels B in the other one of the two pixel rows are connected with the third gate lines. Pixel electrodes of the pixels G in the two pixel rows are connected with the second gate lines.

Further, in the display panel, two data lines are provided with respect to every three pixel columns, and data voltages of polarities opposite to each other are applied to these two data lines, respectively. The pixels R in the two pixel rows are connected with data lines to which positive-polarity data voltages are applied, and the pixels B therein are connected with data lines to which negative-polarity data voltages are applied. The pixels G in one of the two pixel rows are connected with data lines to which negative-polarity data voltages are applied, and the pixels G in the other one of the pixel rows are connected with data lines to which positive-polarity data voltages are applied.

### SUMMARY OF THE INVENTION

In the configuration disclosed in JP-A-2007-188089, for example, in a case where the polarity of a data voltage applied to each data line is inverted at every frame and only red color or blue color is displayed, the polarities of the data voltages applied to the pixels R or the pixels B are unbalanced so as to be largely either the positive polarity or the negative polarity. Accordingly, when the polarities of the data voltages are inverted at every frame, the voltage polarities of the pixels are inverted at every screen, resulting in that flicker occurs.

It is an object of the present invention to provide a liquid crystal display device in which it is unlikely that flicker would occur even if the polarity of the data voltage is inverted at every frame when a single color is displayed.

In order to achieve the above-described object, a liquid crystal display device of the present invention includes: an active matrix substrate; a counter substrate that is arranged so as to be opposed to the active matrix substrate; and a liquid crystal layer interposed between the active matrix substrate and the counter substrate, wherein the active matrix substrate includes a plurality of pixels provided with pixel electrodes arranged in matrix; and a plurality of source lines to each of which a positive-polarity data voltage or a negative-polarity data voltage with respect to a predetermined potential as a reference is applied, wherein the counter substrate includes color filters that have a plurality of different colors, respectively; the source lines are arranged so that two source lines to which data voltages having polarities opposite to each other are applied, respectively, are provided with respect to every three columns of the pixels; the polarities of the data voltages applied to the source lines are inverted at every frame; each of the pixels corresponds to any one of the colors; and regarding each color, the pixels corresponding to the color include the pixels having the pixel electrodes connected with the source lines to which positive-polarity data voltages are applied, and the pixels having the pixel electrodes connected with the source lines to which negative-polarity data voltages are applied.

With the configuration of the present invention, it is unlikely that flicker would occur even if the polarity of the data voltage is inverted at every frame and a single color is displayed.

### BRIEF DESCRIPTION OF DRAWINGS

FIG. 1 shows a schematic configuration of a liquid crystal display device according to Embodiment 1.

FIG. 2 is a top view showing a schematic configuration of an active matrix substrate provided in the liquid crystal display device according to Embodiment 1.

FIG. 3 schematically shows a schematic configuration of a display area shown in FIG. 2.

FIG. 4 schematically shows a partial area in a display area 10R shown in FIG. 3.

FIG. 5A schematically shows exemplary polarities of data voltage signals input to source lines SL shown in FIG. 4, and exemplary polarities of respective voltages of the pixels, in a certain frame.

FIG. 5B shows polarities of pixel voltages when only red color is displayed in FIG. 5A.

FIG. 6 shows polarities of pixel voltages when only red color is displayed, in a case where data voltages having polarities different from those in FIG. 5A are applied.

FIG. 7 schematically shows a partial area of a display area in Embodiment 2.

FIG. 8A schematically shows exemplary polarities of data voltage signals input to source lines SL shown in FIG. 7, and exemplary polarities of respective voltages of the pixels, in a certain frame.

FIG. 8B shows polarities of pixel voltages when only red color is displayed, in a case where data voltages having polarities different from those in FIG. 8A are applied.

FIG. 9 explains a gate line scanning order in Embodiment 3.

FIG. 10 is an equivalent circuit diagram of a unit circuit that composes a gate driver in Embodiment 3.

FIG. 11 is a timing chart showing timings for driving the gate driver shown in FIG. 10 and the gate lines.

FIG. 12 shows polarity changes of pixel voltages of pixels in a part of a display area in a case where the gate lines are scanned in the same scanning order as the conventional scanning order.

FIG. 13 shows polarity changes of pixel voltages of the same pixels in a part of the display area as those shown in FIG. 12, in a case where the gate lines are scanned in the scanning order shown in FIG. 9.

### MODE FOR CARRYING OUT THE INVENTION

The first configuration of the display device according to the present invention includes: an active matrix substrate; a counter substrate that is arranged so as to be opposed to the active matrix substrate; and a liquid crystal layer interposed between the active matrix substrate and the counter substrate, wherein the active matrix substrate includes a plurality of pixels provided with pixel electrodes arranged in matrix; and a plurality of source lines to each of which a positive-polarity data voltage or a negative-polarity data voltage with respect to a predetermined potential as a reference is applied, wherein the counter substrate includes color filters that have a plurality of different colors, respectively; the source lines are arranged so that two source lines to which data voltages having polarities opposite to each other are applied, respectively, are provided with respect to every three columns of the pixels; the polarities of the data voltages applied to the source lines are inverted at every frame; each of the pixels corresponds to any one of the colors; and regarding each color, the pixels corresponding to the color include the pixels having the pixel electrodes connected with the source lines to which positive-polarity data voltages are applied, and the pixels having the pixel electrodes connected with the source lines to which negative-polarity data voltages are applied.

According to the first configuration, two source lines to which data voltages of polarities opposite to each other are applied, respectively, are provided with respect to every three pixel columns, and the polarity of the data voltage of each source line is inverted at every frame. In the pixels corresponding to each color, there are pixels to which positive-polarity data voltages are applied, and pixels to which negative-polarity data voltages are applied. Therefore, even if a single color is displayed, the data voltages applied to the pixels are not biased to either one of the polarities, whereby it is unlikely that flicker would occur.

The first configuration may be further characterized in that the counter substrate further includes common electrodes provided at positions opposed to the pixel electrodes, respectively, wherein the active matrix substrate further includes a plurality of gate lines connected with the pixel electrodes, and a plurality of common electrode lines that are provided approximately in parallel with the source lines and are connected with the common electrodes; the gate lines are arranged in such a manner that three gate lines are provided with respect to two rows of the pixels; the source lines and the common electrode lines are arranged in such a manner that a first source line and a second source line, as the two source lines, and one common electrode line, are provided with respect to three columns of the pixels; and polarities of data voltages for the source lines are set in such a manner that the polarity of the data voltage for the first source line and the polarity of the data voltage for the second source line in a certain pair are opposite to the polarity of the data voltage for the first source line and the polarity of the data voltage for the second source line in another pair adjacent to the said pair, respectively. (the second configuration).

With the second configuration, it is possible to allow the common electrode lines to cause the common electrodes to have lower resistances, and decrease the occurrence of flicker.

The second configuration may be further characterized in that the three gate lines are a first gate line, a second gate line, and a third gate line, and are provided approximately in parallel, in an order of the first gate line, the second gate line, and the third gate line; the pixel of one color among the pixels in the two rows is connected to the second gate line; the pixels of other colors adjacent on the left and right sides to the said pixel of the one color are connected with the first gate line or the third gate line, and the pixels of the other colors are connected with the source lines to which the data voltages having polarities opposite to each other are applied, respectively; and the second gate line is scanned first, among the first gate line, the second gate line, and the third gate line.

According to the third configuration, the second gate line is scanned first. Therefore, after data are written in the pixel of one color, data are written in the pixel of another color connected to the first gate line or the third line. Voltages applied to the pixels of other colors that are adjacent on the left and right sides to the foregoing pixel of the one color have polarities opposite to each other. Therefore, it is unlikely that the pixel of the one color would be affected by voltage changes at the pixels of the other colors when data are written in the pixels of other colors, which makes it possible to reduce the deterioration of the display quality.

The following description describes embodiments of the present invention in detail, while referring to the drawings. Identical or equivalent parts in the drawings are denoted by the same reference numerals, and the descriptions of the same are not repeated.

### EMBODIMENT 1

### Configuration of Liquid Crystal Display Device

FIG. 1 schematically shows a schematic configuration of a liquid crystal display device according to the present embodiment. As shown in FIG. 1, a liquid crystal display device 1 includes a display panel 2 that includes an active matrix substrate 10, a counter substrate 20, and a liquid crystal layer 30 interposed between the active matrix substrate 10 and the counter substrate 20.

Though the illustration is omitted, a pair of polarizing plates are provided on a lower surface of the active matrix substrate 10 and a top surface of the counter substrate 20, respectively. Further, color filters (not illustrated) of three colors, i.e., red (R), green (G), and blue (B), are formed on the counter substrate 20.

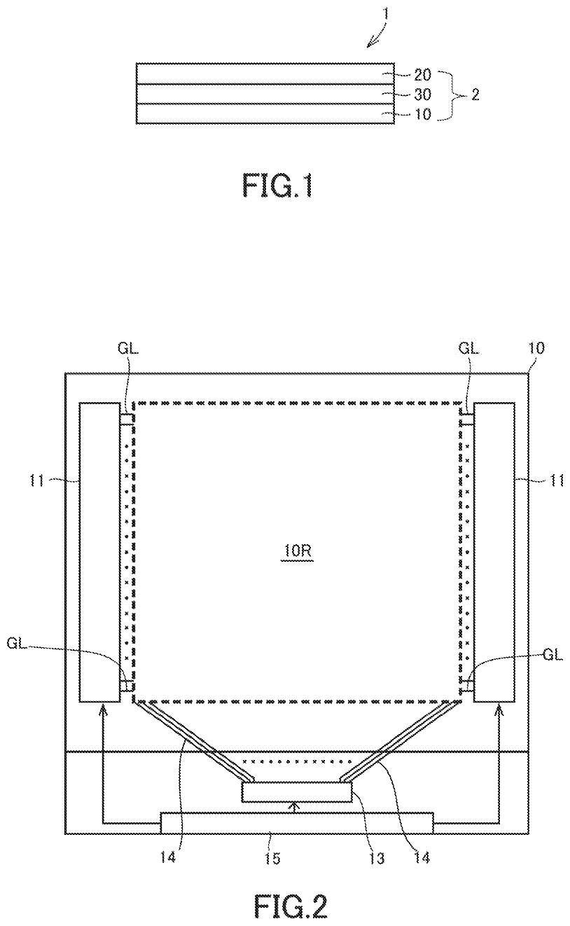

FIG. 2 schematically shows a schematic configuration of the active matrix substrate 10. As shown in FIG. 2, the active matrix substrate 10 has a display area 10R, and includes gate drivers 11, a source driver 13, lines 14, and a terminal part 15 outside the display area 10R.

Each of the gate drivers 11 and the source driver 13 is electrically connected with the terminal part 15. The source driver 13 is electrically connected with the lines 14. To the terminal part 15, timing signals, control signal, and the like for driving the gate drivers 11 and the source driver 13 are input from a display control circuit that is not shown.

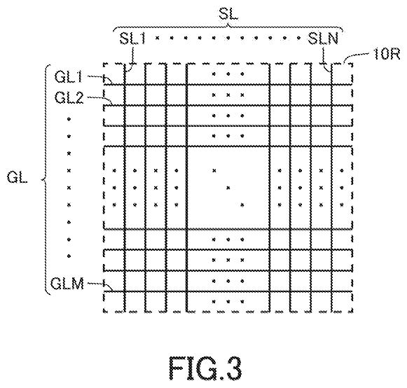

FIG. 3 schematically shows a schematic configuration of the display area 10R. As shown in FIG. 3, in the display area 10R of the active matrix substrate 10, there are provided a plurality of gate lines GL (GL1 to GLM), and a plurality of source lines SL (SL1 to SLN) that intersect with the gate lines GL.

Each gate line GL is connected to with the gate driver 11 (FIG. 2). In this example, the gate drivers 11 are provided at the ends on both sides of the gate lines GL. The gate lines GL can be sequentially switched to the selected state by simultaneously driving the two gate drivers 11 connected to the gate lines GL. In the following description, the operation of switching the gate lines GL into a selected state is called “driving” or “scanning” of the gate lines GL.

Each of the source line SL is electrically connected with the source driver 13 (FIG. 3) via the lines 14 (FIG. 3), which are connected to the source driver 13. To the source lines SL, data voltage signals are input from the source driver 13 through the lines 14.

In this example, the data voltage signal has either a positive polarity or a negative polarity with respect to a potential of a common electrode (not illustrated) provided on the counter substrate 20 as a reference potential. The source driver 13 inverts the polarity of the data voltage signal to the source line SL at every frame.

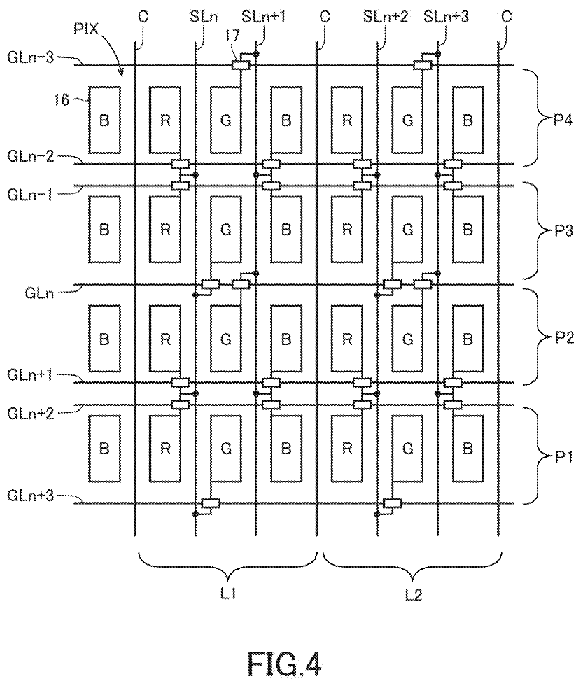

Next, the following description describes a more specific configuration of the display area 10R in the present embodiment, while referring to FIG. 4. FIG. 4 schematically shows a part of the display area 10R shown in FIG. 3.

As shown in FIG. 4, in the display area 10R, the pixel electrodes 16 are arranged in matrix. An area PIX where one pixel electrode 16 is provided constitutes a pixel, and in this drawing, the pixels in four pixel rows P1 to P4 are partially shown as an example.

Further, though the illustration is omitted in this drawing, common electrodes are provided so as to be opposed to the pixel electrodes 16 of the respective pixels, with an insulating film being interposed between. The common electrode is formed with, for example, a transparent conductive film made of ITO or the like, and a predetermined voltage is applied thereto.

In FIG. 4, the characters of “R”, “B”, and “B” denoting the respective pixel electrodes 16 indicate the colors of the color filters. The pixels corresponding to the color of R are referred to as pixels R, the pixels corresponding to the color of G are referred to as pixels G, and the pixels corresponding to the color of B are referred to as pixels B. In this example, the pixels are arrayed in the order of the pixel R, the pixel G, and the pixel B in each pixel row.

Besides, in the present embodiment, the source lines SL are provided in such a manner that two source lines SL are provided per three pixel columns. More specifically, as shown in FIG. 4, the source lines SLn and SLn+1 are provided with respect to the pixel column L1 including three columns of pixels, and the source lines Sln+2 and Sln+3 are provided with respect to the pixel column L2 including three columns of pixels. Further, one common electrode line C is provided with respect to each of the pixel columns L1 and L2. The common electrode lines C are connected with the common electrodes (not illustrated). By providing the common electrode lines C, the resistance distribution of the common electrode (not illustrated) is reduced, whereby the display quality is improved.

The pixel electrode 16 is connected with a switching element 17, and is connected with one gate line GL and one source line SL via the switching element 17. The switching element 17 is formed with, for example, a thin film transistor. The switching element 17 has a gate connected with the gate line GL, a source connected with the source line SL, and a drain connected with the pixel electrode 16.

In this example, the gate lines GLn−1, GLn, and GLn+1 are provided with respect to the pixel rows P2, P3 among the pixel rows P1 to P4. The pixel electrodes 16 of the pixels G in the pixel row P2 are connected with the gate line GLn via the switching elements 17. The pixel electrodes 16 of the pixels R and B in the pixel row P2 are connected with the gate line GLn+1 via the switching elements 17. Further, the pixel electrodes 16 of the pixels G in the pixel row P3 are connected with the gate line GLn via the switching elements. The pixel electrodes 16 of the pixels R and B in the pixel row P3 are connected with the gate line GLn−1 via the switching elements 17.

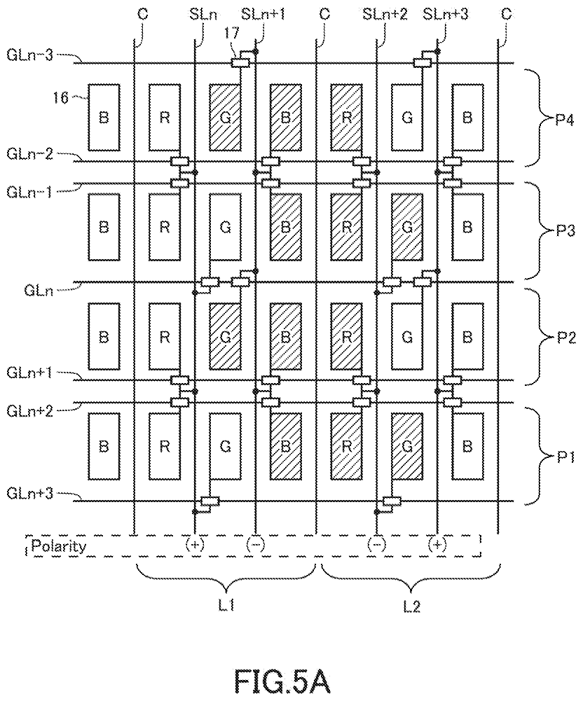

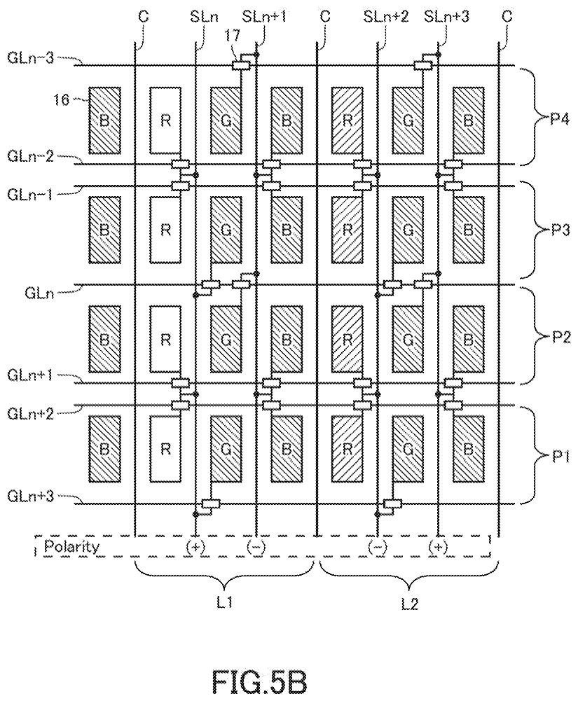

FIG. 5A schematically shows exemplary polarities of data voltage signals input to the source lines SL shown in FIG. 4, and exemplary polarities of respective voltages of the pixels, in a certain frame. Further, in the present embodiment, data voltages of polarities opposite to each other are applied to two source lines SL of each pixel column, respectively. Further, to the two source lines SL of a certain pixel column, data voltages of polarities respectively opposite to those for two source lines of another pixel column adjacent to the foregoing pixel column are applied, respectively.

In other words, as shown in FIG. 5A, in this example, positive-polarity (+) data voltage signals are input to the source lines SLn and SLn+3, and negative-polarity (−) data voltage signals are input to the source lines SLn+1 and SLn+2, in a certain frame. In this case, in FIG. 5A, negative-polarity data voltages are applied to the pixels indicated by hatching with lines rising to the right, and positive-polarity data voltages are applied to the pixels indicated as void.

Here, polarities of pixel voltages in a case where only red color is displayed in the configuration shown in FIG. 5A are shown in FIG. 5B. In FIG. 5A, the pixels G and B indicated by hatching with lines rising to the left are assumed to display black. For example, in a case where the display panel 2 is of the normally black type, black is displayed by not applying a voltage to the pixels G and B. Here, among the pixels R, there are the pixels R to which positive-polarity data voltages are applied, and the pixels R to which negative-polarity data voltages are applied. In other words, positive-polarity data voltages are applied to the pixels R (void) connected to the source line SLn to which positive-polarity data voltage signals are applied, and negative-polarity data voltages are applied to the pixels R (hatched with lines rising to the right) connected to the source line Sln+2 to which negative-polarity data voltage signals are applied.

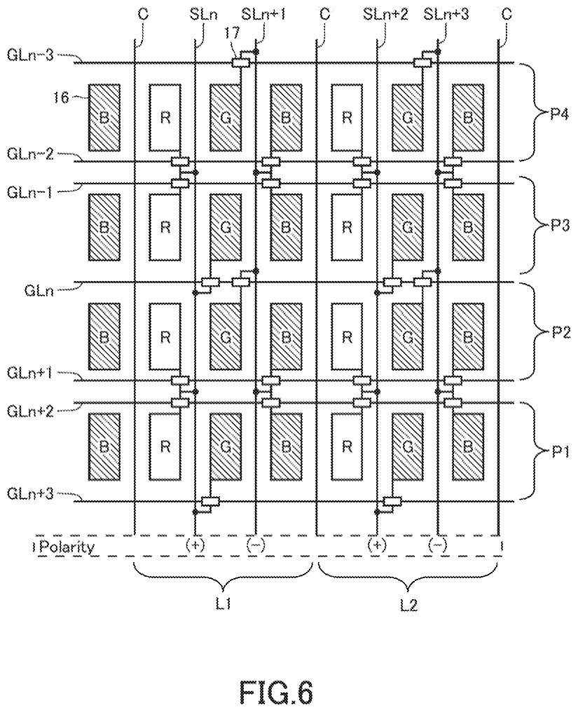

Next, voltage polarities of the pixels in such a configuration where positive-polarity data voltages and negative-polarity data voltages are alternately applied to four source lines SL of two adjacent pixel columns in the same configuration as that in FIG. 4 are shown in FIG. 6. Incidentally, in FIG. 6, voltage polarities of the pixels in a case where only red color is displayed are shown.

As shown in FIG. 6, in this case, positive-polarity (+) data voltage signals are input to the source lines SLn and SLn+2, and negative-polarity (−) data voltage signals are input to the source lines SLn+1 and SLn+3, in a certain frame. Therefore, when only red color is caused to be displayed, positive-polarity data voltages are applied to the pixels R connected to the source line SLn, and the pixels R connected to the source line Sln+2. In other words, in the case of the configuration shown in FIG. 6, when only red color is displayed, the polarities of data voltages applied to the pixels R are biased to either one of the polarities.

Therefore, if the polarity of the data voltage signal supplied to the source line SL is inverted at every frame in the configuration shown in FIG. 6, the polarity of the pixel voltage is inverted at every frame, which results in that flicker occurs.

On the other hand, in the present embodiment, among the pixels R in the display area 10R, there are the pixels R to which positive-polarity data voltages are applied, and the pixels R to which negative-polarity data voltages are applied. Therefore, even if only red color is displayed and the polarities of the data voltage signals input to the source lines SL are inverted at every frame, the voltage polarities of the pixels are not biased to one polarity, which makes it unlikely that flicker would occur.

Incidentally, the above-described example is described as an exemplary case where only red color is displayed on the display panel 2; the foregoing description applies to a case where only green or only blue is displayed. In other words, in the configuration illustrated in FIG. 5A, among the pixels B in the display area 10R, there are the pixels B to which positive-polarity data voltages are applied, and the pixels B to which negative-polarity data voltages are applied. Further, among the pixels G in the display area 10R, there are the pixels G to which positive-polarity data voltages are applied, and the pixels G to which negative-polarity data voltages are applied. Therefore, even if black color is displayed in the pixels R, as well as the pixels G or B and the polarities of the data voltage signals input to the source lines SL are inverted at every frame, the voltage polarities of the pixels are not biased to one polarity, which makes it unlikely that flicker would occur.

### EMBODIMENT 2

The present embodiment is described with reference to an exemplary case where the connection of the pixel electrodes 16 with the gate lines GL and the source lines SL is different from that in Embodiment 1.

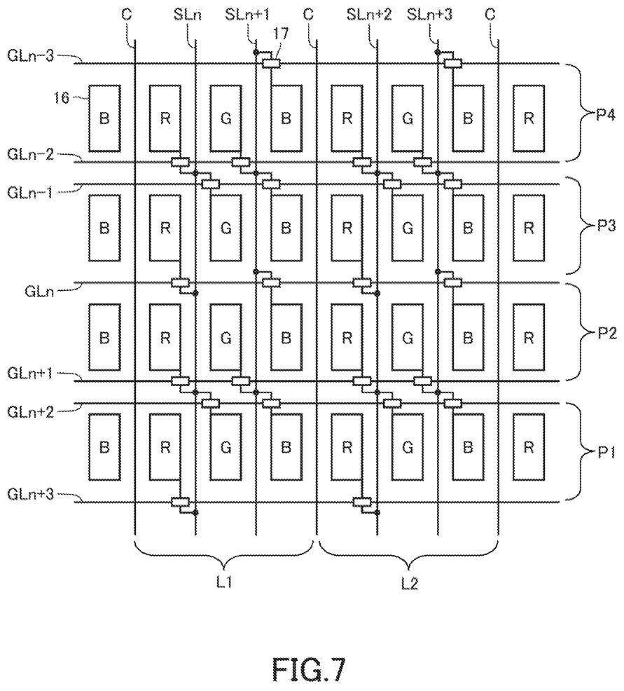

FIG. 7 schematically shows a part of the display area 10R. In FIG. 7, members identical to those shown in FIG. 4 in Embodiment 1 are denoted by the same reference symbols as those in FIG. 4.

As shown in FIG. 7, as is the case with Embodiment 1, the gate lines GL, the source lines SL, and the common electrode lines C are provided in such a manner that three gate lines GL are provided with respect to two pixel rows, and two source lines SL and one common electrode line C are provided with respect to three pixel columns.

In the present embodiment, each of the pixel electrodes 16 of the pixels R and G in the pixel row P2 is connected with the gate line GLn+1 via the switching element 17, and each of the pixel electrodes 16 of the pixels B and R in the pixel rows P2, P3 is connected with the gate line GLn via the switching element 17. Further, each of the pixel electrodes 16 of the pixels G and B in the pixel row P3 is connected with the gate line GLn−1 via the switching element 17.

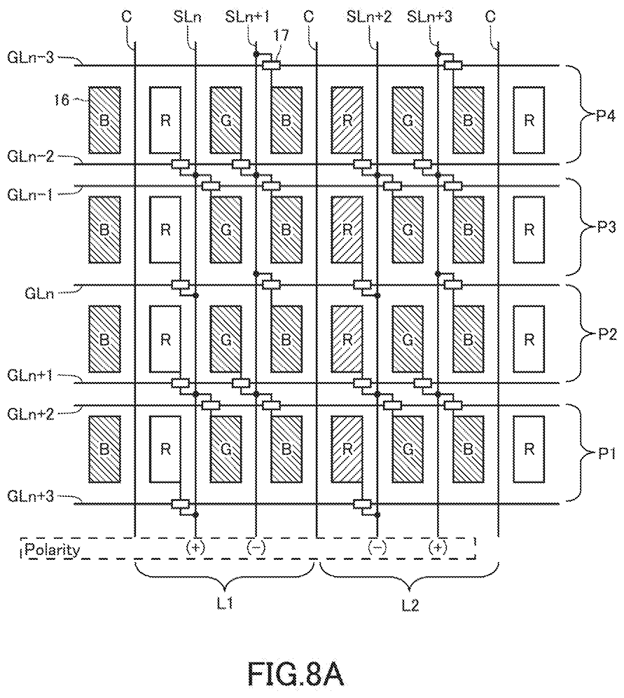

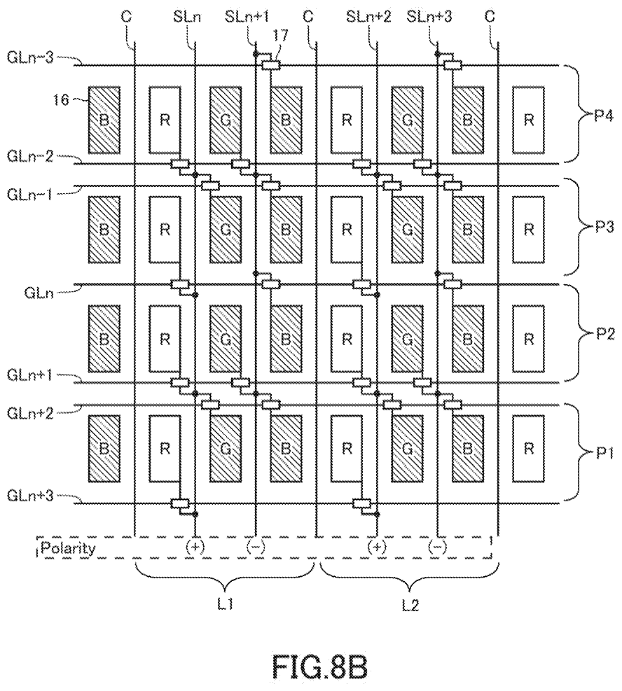

In this example, during a certain frame period, positive-polarity (+) data voltage signals are input to the source lines SLn and SLn+3, respectively, and negative-polarity (−) data voltage signals are input to the source lines SLn+1 and SLn+2, respectively. In this case, if only red color is displayed, as shown in FIG. 8A, positive-polarity data voltages are applied to the pixels R (void) connected with the source line SLn, and negative-polarity data voltages are applied to the pixels R (hatched with lines rising to the right) connected with the source line SLn+2. In other words, among the pixels R, there are the pixels R to which positive-polarity data voltages are applied, and the pixels R to which negative-polarity data voltages are applied.

Incidentally, the following example is assumed: the polarities of the data voltage signals input to the source lines SLn+2 and SLn+3 shown in FIG. 8A are changed so as to have opposite ones, respectively, so that positive-polarity (+) data voltage signals are input to the source line SLn+2, and negative-polarity (−) data voltage signals are input to the source line SLn+3 as shown in FIG. 8B, to display only red color. In this case, the voltage polarities of the pixels R are biased to the positive polarity. Therefore, if the polarities of the data voltage signals input to the source lines SL are inverted at every frame, the voltage polarities of the pixels are inverted, which causes flicker to occur.

In the present embodiment, as shown in FIG. 8A, in each case of the pixels R, G, and B, there are the pixels to which positive-polarity data voltages and are applied, and the pixels to which negative-polarity data voltages are applied. Therefore, even if only one color among R, G, and B is displayed and the polarities of the data voltage signals are inverted at every frame, the voltage polarities of any of the pixels R, G, and B are not biased to either one polarity, which makes it unlikely that flicker would occur.

### EMBODIMENT 3

Embodiment 1 described above is described with reference to an example in which the gate lines GL are scanned sequentially one by one from the top or from the bottom; the present embodiment is described with reference to an example in which the gate lines GL are scanned in an order different from that in Embodiment 1.

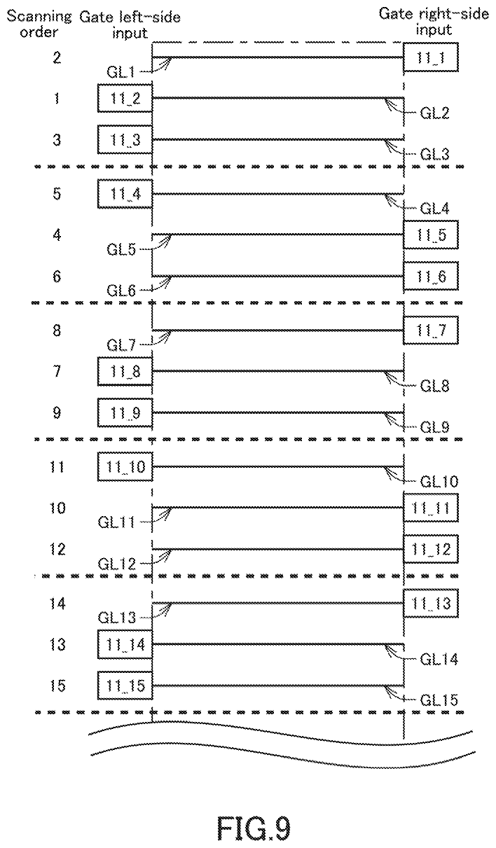

More specifically, the gate lines are scanned in the order of GL2, GL1, GL3, GLS, GL4, GL6, GL8, GL7 . . . , as shown in FIG. 9. In other words, the gate lines are scanned sequentially from the top in such a manner that every three consecutive gate lines GL (GLn−1, GLn, GLn+1 (n is an integer of 2 or greater) are in the order of GLn, GLn−1, GLn+1.

In this example, the gate drivers 11 (11_1, 11_5, 11_6, 11_7 . . . ) for driving the gate lines GL1, GL5, GL6, GL11, . . . shown in FIG. 2 are arranged on the right side with respect to these gate lines GL, and the gate drivers 11 (11_2, 11_3, 11_4, 11_8 . . . ) for driving the gate lines GL2, GL3, GL4, GLB, . . . shown in FIG. 2 are arranged on the left side with respect to these gate lines GL

The terminal part 15 (see FIG. 2) and each gate driver 11 are connected with each other by a signal line, and control signals for driving the gate drivers 11 are supplied to each gate driver 11 from the terminal part 15 via the signal lines. In this example, the control signals include clock signals CKA, CKB and a reset signal CLR.

Each of the clock signals CKA and CKB has a potential at a high (H) level and a potential at a low (L) level periodically in certain cycles (for example, one horizontal scanning period) in such a manner that the clock signals CKA and CKB have phases opposite to each other, respectively. The reset signal CLR has a potential that is at the H level for a certain period.

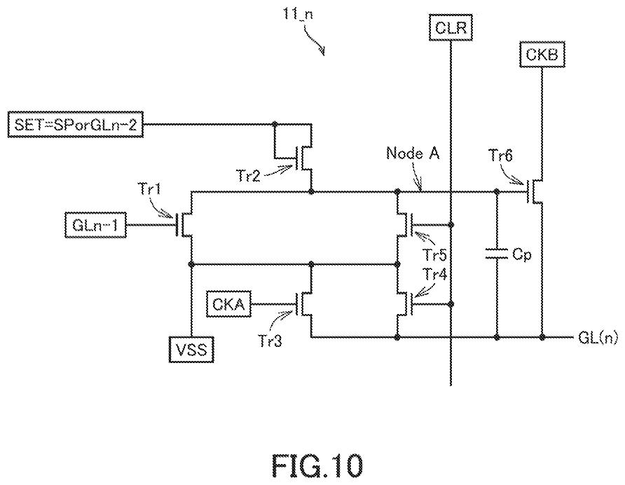

Here, FIG. 10 shows an equivalent circuit diagram of a gate driver (unit circuit) 11_n that drives one gate line GLn. As shown in FIG. 10, the gate driver 11_n includes six switching elements denoted by Tr1 to Tr6, and a capacitor Cp.

In the gate drivers 11_n, an internal line to which a drain of the switching element Tr1, a drain of the switching element Tr2, a drain of the switching element Tr5, one of electrodes of the capacitor Cp, and a gate of the switching element Tr6 are connected is referred to as a node A.

The switching element Tr1 has a gate connected with the gate line GLn−1, a source to which a power source voltage VSS is supplied, and a drain connected with the node A.

The switching element Tr2 has a gate and a source to which a SET signal is input. The SET signal is a potential of the gate line GLn−2 (n≥3) or a start pulse signal SP.

The switching elements Tr2 in the gate drivers 11_1 and 11_2 are connected with signal lines to which the start pulse signal SP is supplied. Further, each of the switching elements Tr2 of the gate driver 11_3 and subsequent gate drives is connected with the gate line GLn−2 at the second stage previous to the gate line GLn that is driven by the gate driver 11 concerned. Still further, the drain of the switching element Tr2 is connected with the node A.

The switching element Tr3 has a gate connected with a signal line that supplies the clock signal CKA, a source to which the power source voltage VSS is supplied, and a drain connected with the respective drains of the switching elements Tr4 and Tr6 as well as the other electrode of the capacitor Cp.

The switching element Tr4 has a gate connected with a signal line that supplies the reset signal CLR, a source to which the power source voltage VSS is supplied, and a drain connected with the gate line GLn.

The switching element Tr5 has a gate connected with a signal line that supplies the reset signal CLR, a source to which the power source voltage VSS is supplied, and a drain connected with the node A.

The switching element Tr6 has a gate connected with the node A, a source connected with a signal line that supplies the clock signal CKB, and a drain connected with the gate line GLn.

The capacitor Cp has an electrode connected with the node A, and an electrode connected to the respective drains of the switching elements Tr3, Tr4, and Tr6 as well as the gate line GLn.

Incidentally, a clock signal having a phase opposite to that of the clock signal supplied to the switching elements Tr3 and Tr6 of the gate driver 11_n is input to the switching elements Tr3 and Tr6 of the gate drivers 11_n−2 and 11_n−1. In other words, the clock signals CKB and CKA are input to the switching elements Tr3 and Tr6 of each of the gate drivers 11_n−2 and 11_n−1, respectively. The clock signals having phases opposite to each other are input to the gate drivers 11 for driving the odd-numbered gate lines GL and the gate drivers 11 for driving the even-numbered gate lines GL, respectively.

Further, the switching elements Tr1, Tr2 of the gate driver 11_n+3 corresponding to the third gate line subsequent to the gate line GLn driven by the gate driver 11_n are connected with the gate line GLn+2 in the stage previous to that of the gate line GLn+3 driven by the gate driver 11_n+3, and the gate line GLn+1, which is the second gate line previous thereto, respectively, as is the case with the gate driver 11_n. On the other hand, the lines connected with the switching elements Tr1 and Tr2 of the gate drives 11_n−1 and 11_n+1 corresponding to the gate lines GLn−1 and GLn+1, which are provided in the stages previous to and subsequent to the gate line GLn, respectively, are different from those in the case of the gate driver 11_n. More specifically, the switching element Tr1 of the gate driver 11_n+1 is connected with the gate line GLn+3, and the switching element Tr2 thereof is connected with the gate line GLn−1. The switching element Tr1 of the gate driver 11_n−1 is connected with the gate line GLn+1, and the switching element Tr2 thereof is connected with the gate line GLn.

In other words, the switching element Tr1 of the gate driver 11_n is connected with the gate line GLn−1 in the stage previous to that of the gate line GLn, while the switching elements Tr1 of the gate drivers 11_n+1 and 11_n−1 are connected with the second gate line subsequent to the gate line GLn. Further, the switching element Tr2 of the gate drive 11_n−1 is connected with the gate line GLn in the stage subsequent to that of the gate line GLn−1, while the switching elements Tr2 of the gate drivers 11_n and 11_n+1 are connected with the second gate lines previous to the gate lines driven by the gate drivers concerned, respectively. Incidentally, the switching elements Tr1 and Tr2 of the gate driver 11_n+2 for driving the gate line GLn+2 are connected to the second gate line subsequent to the gate line GLn+2 and the gate line in the stage previous to that of the gate line GLn+2, as is the case with the gate driver 11_n−1. Further, the switching elements Tr1 and Tr2 of the gate driver 11_n−2 for driving the gate line GLn−2 are connected to the second gate line subsequent to the gate line GLn−2 and the second gate line previous to the gate line GLn−2, respectively, as is the case with the gate driver 11_n+1.

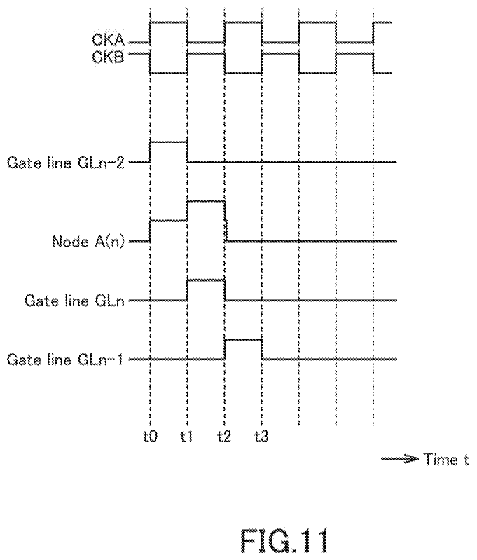

FIG. 11 shows voltage waveforms of the clock signals CKA and CKB, as well as voltage waveforms of the gate line GL and the node A(n) of the gate drivers 11_n.

At time t0, the gate line GLn−2 becomes selected, and the potential of the gate line GLn−2 shifts to the H level. Here, the switching element Tr2 of the gate drivers 11_n (n≥3) is turned ON, and a potential lower than the potential of the gate line GLn−2 is charged to the node A. The potential of the clock signal CKB is at the L level, and the potential at the L level is input from the switching element Tr6 to the gate line GLn.

At time t1, the potential of the clock signal CKB makes a transition to the H level. The potential at the H level is input to the source of the switching element Tr6, and the potential at the H level is output from the switching element Tr6. Here, the potential of the node A(n) is boosted due to a parasitic capacitance of the switching element Tr6 and the capacitor Cp. This causes the potential at the H level to be input to the gate line GLn, whereby the gate line GLn becomes selected.

At time t2, the potential of the clock signal CKA makes a transition from the L level to the H level, and the potential of the clock signal CKB makes a transition from the L level to the H level. This causes the switching element Tr3 to be turned ON, which causes a potential of the power source voltage VSS, i.e., a potential at the L level, to be input to the gate line GLn, whereby the gate line GLn becomes non-selected.

Further, at time t2, the gate driver 11_n−1 causes the gate line GLn−1 to become selected, as is the case with the gate line GLn, whereby the potential of the gate line GLn−1 shifts to the H level. Here, this causes the switching element Tr1 to be turned ON, which causes a potential of the power source voltage VSS, i.e., a potential at the L level, to be input to the node A(n). The switching element Tr6 is turned OFF, and the gate line GLn maintains the potential at the L level.

In the display area 10R, the gate drivers 11 provided on the left side with respect to the gate lines GL are driven sequentially from the top, and the gate drivers 11 provided on the right side with respect to the gate lines GL are driven sequentially from the top, whereby the gate lines GL are scanned in the scanning order shown in FIG. 9. Scanning the gate lines GL in the scanning order shown in FIG. 9 makes it possible to prevent the pixel voltages of the pixels connected to the gate line GL being scanned from affecting the pixel voltages of the pixels adjacent to the foregoing pixels.

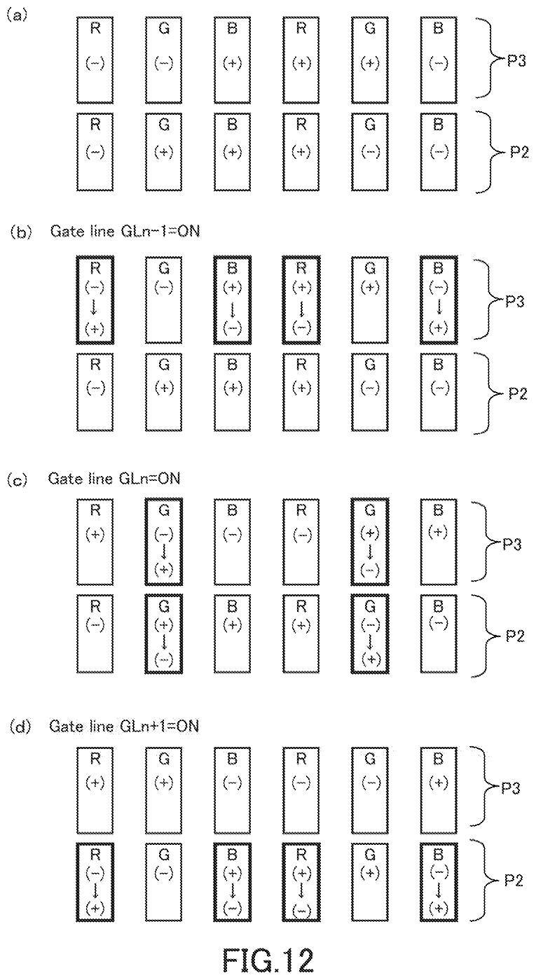

(a) to (d) in FIG. 12 schematically show pixels extracted from the pixel rows P2 and P3 shown in FIG. 4. (a) of FIG. 12 show voltage polarities ((+) or (−)) of the pixels after data voltage signals are applied, in the M-1′th frame.

(b) to (d) of FIG. 12 show changes of the voltage polarities at the pixels in a case where the gate lines are scanned in the order of GLn−1, GLn, GLn+1 shown in FIG. 4, in the M′th frame.

The pixels indicated with thick-line frames in (b) of FIG. 12 are the pixels connected with the gate line GLn−1. The pixels indicated with thick-line frames in (c) of FIG. 12 are the pixels connected with the gate line GLn. The pixels indicated with thick-line frames in (d) of FIG. 12 are the pixels connected with the gate line GLn+1.

Incidentally, in (b) to (d) of FIG. 12, the pixels indicated with thick-line frames indicate the pixels connected with the gate line GL driven, that is, the pixels into which data are written. The polarity indicated in the upper part in the thick-line frame indicates the polarity of the pixel voltage in the M-1′th frame, and the polarity indicated in the lower part in the thick-line frame indicates the polarity of the pixel voltage applied in the M′th frame.

When the gate line GLn−1 is scanned, as shown in (b) of FIG. 12, to the pixels R and B in the upper stage (P3) connected with the gate line GLn−1, pixel voltages having polarities opposite to those of the pixel voltages of the same pixels in the M-1′th frame shown in (a) of FIG. 12 are applied. The other pixels maintain the same polarities as those of the pixel voltages of these pixels in the M-1′th frame.

When the gate line GLn is scanned, as shown in (c) of FIG. 12, to the pixels G connected with the gate line GLn, pixel voltages having polarities opposite to those of the pixel voltages of the same pixels G shown in Fig. (b) of 12 are applied. Here, the pixel voltages of the pixels R and B in the upper stage (P3) to which data have been written are affected by changes in the pixel voltages of the pixels G adjacent on the left and right sides thereto, fluctuating in the positive or negative directions.

Next, when the gate line GLn+1 is scanned, as shown in (d) of FIG. 12, to the pixels R and B in the lower stage (P2) connected with the gate line GLn+1, pixel voltages having polarities opposite to those of the pixel voltages of the same pixels in the M-1′th frame shown in (c) of FIG. 12 are applied.

In this way, when the gate lines GLn−1, GLn, and GLn+1 are scanned in the stated order, the pixel voltages of the pixels connected with the gate line GLn−1, to which data have been written previously, fluctuate, being affected by changes in the pixel voltages of the pixels connected with the gate line GLn that is scanned next. Consequently, white balance varies between the pixels R and B in the odd-numbered rows, and the pixels R and B in the even-numbered rows. This causes horizontal stripes to easily occur particularly when halftone is displayed.

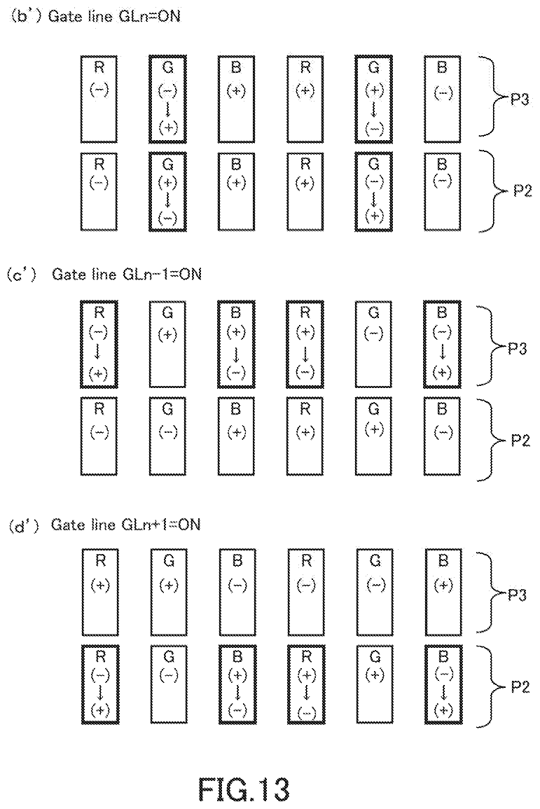

In the present embodiment, horizontal strips do not occur, since the gate lines GL are scanned in the scanning order shown in FIG. 9. (b′) to (d′) of FIG. 13 show changes of the voltage polarities at the pixels in a case where the gate lines GL are scanned in the order shown in FIG. 9, that is, in the order of the gate lines GLn, GLn−1, GLn+1. Incidentally, the pixels shown in (b′) to (d′) of FIG. 13 are the same pixels as those shown in (a) of FIG. 12.

(b′) of FIG. 13 shows a state in which, after the M-1′th frame shown in (a) of FIG. 12, the gate line GLn is scanned in the M′th frame, and data are written in the pixels G connected with the gate GLn. As shown in (b′) of FIG. 13, to the pixels G in the upper and lower stages, pixel voltages having polarities opposite to those of the pixel voltages applied to the same pixels in the M-1′th frame, shown in (a) FIG. 12, are applied. Here, the other pixels maintain the same polarities as those of the pixel voltages of these pixels in the M-1′th frame.

Next, when the gate line GLn−1 is scanned, as shown in (c′) of FIG. 13, to the pixels R and B in the upper stage (P3) connected with the gate line GLn−1, pixel voltages having polarities opposite to those of the pixel voltages of the same pixels in the M-1′th frame illustrated in (a) of FIG. 12 are applied. Here, the pixels G in the upper stage (P3) are affected by changes in the pixel voltages of the pixels R and B adjacent thereto. However, voltages having polarities opposite to each other are applied to the pixels R and B, thereby causing the changes in the voltages of the pixels R and B affecting the pixels G in the upper stage to be canceled. Therefore, the pixels G in the upper stage are substantially not affected by voltage changes.

Next, when the gate line GLn+1 is scanned, as illustrated in (d′) of FIG. 13, to the pixels R and B in the lower stage (P2) connected with the gate line GLn+1, pixel voltages having polarities opposite to those of the pixel voltages of the same pixels in the M-1′th frame illustrated in (a) of FIG. 12 are applied. Here, the pixels G in the upper stage (P2) are affected by changes in the pixel voltages of the pixels R and B adjacent thereto. However, voltages having polarities opposite to each other are applied to the pixels R and B, thereby causing the changes in the voltages of the pixels R and B affecting the pixels G in the lower stage to be canceled. Therefore, the pixels G in the lower stage are substantially not affected by voltage changes.

The present embodiment is described with reference to an example in which three gate lines GLn−1, GLn, and GLn+1, provided with respect to every two pixel rows, are scanned in the order of GLn, GLn−1, and GLn+1. The gate lines, however, may be scanned in the order of GLn, GLn+1, and GLn−1.

As described above, the middle gate line GLn is scanned first among the three gate lines GLn−1, GLn, and GLn+1 provided with respect to every two pixel rows, thereby making it unlikely that the pixels R and B connected to the gate lines GLn−1 and GLn+1 would be affected by voltage changes of the pixels G connected to the gate line Gn. In other words, in a case where the pixels of one color in two pixel rows are connected to the middle gate line and data voltages having different polarities are applied to the pixels of the other colors that are adjacent on the left and right sides to the foregoing pixels, the middle gate line is scanned first. This makes it unlikely that a pixel voltage of a pixel to which data have been written earlier would be affected by a data voltage applied to a pixel to which data are written later.

### MODIFICATION EXAMPLE

The embodiments of the present invention, which are described above, are not limited to the above-described specific examples; the embodiment may vary in many ways.

(1) Further, the above Embodiments 1 and 2 are described with reference to an exemplary configuration in which gate drivers 11 are provided at ends on both sides of the gate lines GL, and one gate line GL is scanned simultaneously by two gate drivers 11. The configuration however may be such that one gate line GL may be scanned by one gate driver 11.

(2) Further, the above embodiments are described with reference to an exemplary configuration the gate drivers 11 are provided outside the display area 10R. The configuration however may be such that all or a part of the elements that compose the gate drivers 11 are provided in the display area 10R.

(3) Still further, in the above embodiments, regarding every type of the pixels R, the pixels G, and the pixels B, it is preferable that the number of the pixels connected to the source lines to which positive-polarity data voltages are applied, and the number of the pixels connected to the source lines to which negative-polarity data voltages are applied, are approximately equal to each other. These numbers, however, are not necessarily equal to each other. Any configuration is applicable as long as the polarities of the pixels displayed are not biased to either one of the polarities, in a case where the polarities of data voltages are inverted at every frame, when a single color is displayed.

1. A liquid crystal display device, comprising: an active matrix substrate; a counter substrate that is arranged so as to be opposed to the active matrix substrate; and a liquid crystal layer interposed between the active matrix substrate and the counter substrate,
wherein the active matrix substrate includes:
a plurality of pixels provided with pixel electrodes arranged in matrix; and
a plurality of source lines to each of which a data voltage having either a positive polarity or a negative polarity with respect to a predetermined potential as a reference is applied,
wherein the counter substrate includes color filters that have a plurality of different colors, respectively, and
wherein the source lines are arranged so that two source lines to which data voltages having polarities opposite to each other are applied, respectively, are provided with respect to every three columns of the pixels,
the polarities of the data voltages applied to the source lines are inverted at every frame,
each of the pixels corresponds to any one of the colors, and
regarding each color, the pixels corresponding to the color include the pixels having the pixel electrodes connected with the source lines to which positive-polarity data voltages are applied, and the pixels having the pixel electrodes connected with the source lines to which negative-polarity data voltages are applied.

2. The liquid crystal display device according to claim 1,
wherein the counter substrate further includes common electrodes provided at positions opposed to the pixel electrodes, respectively,
wherein the active matrix substrate further includes:
a plurality of gate lines connected with the pixel electrodes; and
a plurality of common electrode lines that are provided approximately in parallel with the source lines and are connected with the common electrodes,
the gate lines are arranged in such a manner that three gate lines are provided with respect to two rows of the pixels,
the source lines and the common electrode lines are arranged in such a manner that a first source line and a second source line, as the two source lines, and one common electrode line, are provided with respect to three columns of the pixels, and
polarities of data voltages for the source lines are set in such a manner that the polarity of the data voltage for the first source line and the polarity of the data voltage for the second source line in a certain pair are opposite to the polarity of the data voltage for the first source line and the polarity of the data voltage for the second source line in another pair adjacent to the said pair, respectively.

3. The liquid crystal display device according to claim 2,
wherein the three gate lines are a first gate line, a second gate line, and a third gate line, and are provided approximately in parallel, in an order of the first gate line, the second gate line, and the third gate line,
the pixel of one color among the pixels in the two rows is connected to the second gate line,
the pixels of other colors adjacent on the left and right sides to the said pixel of the one color are connected with the first gate line or the third gate line, and the pixels of the other colors are connected with the source lines to which the data voltages having polarities opposite to each other are applied, respectively, and
the second gate line is scanned first, among the first gate line, the second gate line, and the third gate line.
